(19) United States
(12) Patent Application Publication
(10) Pub. No.: US 2010/0028637 A1
(43) Pub. Date: Feb. 4, 2010

(54) Multi-Layer Film Comprising a Barrier Layer and an Antistatic Layer

(75) Inventors: Buelent Tavsanli, Istanbul (TR); Afsin Dogan, Istanbul (TR); Andreas Grewe, Rheine (DE); Atilla Teoman Bostan, Istanbul (TR)

Correspondence Address: BOHAN MATHERS, PO BOX 17707, PORTLAND, ME, 04112-8707, US

(73) Assignee: Sunjuet Deutschland GmbH

(21) Appl. No.: 11/993,569

(22) PCT Filed: Jun. 20, 2006
(86) PCT No.: PCT/DE06/01053

§ 371 Date: Mar. 21, 2008

(30) Foreign Application Priority Data
Jun. 22, 2005 (DE) 10 2005 028 778.6

(51) Int. Cl. B32B 7/02

(52) U.S. Cl. 428/215

(57) ABSTRACT

The invention relates to a multi-layer film comprising a barrier layer, a poorly extensible plastic layer, and an antistatic plastic layer arranged on the side of the barrier layer, opposing the poorly extensible plastic layer. According to the invention, either a layer of material that is generally recognised as safe in terms of food is arranged next to the antistatic plastic layer, opposing the barrier layer, said layer of material being between 5 and 20 μm thick, and the antistatic layer being approximately between 10 and 150 μm thick, or the antistatic plastic layer is embodied as a layer of material that is generally recognised as safe in terms of food, the antistatic plastic layer containing a plastic material that is generally recognised as safe in terms of food and an antistatic agent that is generally recognised as safe in terms of food.

### BACKGROUND INFORMATION

1. Field of the Invention

The invention relates to the field of multi-layer film. More particularly, the invention relates to a multi-layer film having a barrier layer, a plastic layer with limited extensibility, and a plastic layer of antistatic material.

2. Description of the Prior Art

U.S. Pat. No. 5,110,669 discloses such a multi-layer film that is used for packaging electrostatically sensitive products, e.g., electronic components. German prior art reference DE 92 07 044 discloses a transparent antistatic composite film that is also used for bags and wrappings for electronic components. In each case, a metallic layer is provided that protects the contents of the package from electromagnetic (radio frequency) fields, so that this metallic layer can be designated as a “barrier layer”, even if, as in the case of the secondly named reference DE 92 07 044, the barrier layer is so thin that the composite film is transparent.

German prior art reference DE 44 31 046 A1 discloses a plastic packaging container that has container walls made of a composite film, which is supposed to exhibit improved ability to dissipate electrostatic charge. In this case, the side of the composite film facing the product has a perforation, which enables a charge transfer of an electrical charge to an electrically conductive intermediate layer in the composite film. Such a container is not approved for contact with foodstuffs or pharmaceutical products, because their contact with the electrically conductive, for example, metallic, intermediate layer is not approved.

Multi-layer films with a metallic barrier layer are also known in the industry. These are used, for example, to create flexible containers, for example, as film pouches or inside liners, also referred to as inliners, for a bulk packaging, such as a Flexible Intermediate Bulk Container (FIBC), which is hereinafter referred to as “big bag”. In these cases, the barrier layer is customarily intended to protect the packaged product against air or, in particular, oxygen or moisture.

It is known in the field of art, to provide a layer with limited extensibility in the film to protect the very thin barrier layer. This limited-extensibility layer essentially absorbs tensile forces. The barrier layer is thus protected from overexpansion and damage resulting therefrom, such as rips or tears.

It is a problem in the industry to produce a flexible container or a film suitable for the production of the container that, on the one hand, is electrically dissipative and, on the other hand, is also approved for foodstuffs and, therefore, suitable for packaging products from the food or pharmaceutical industries. The various requirements for packing foodstuffs and pharmaceuticals pose significant conflicts in the goals for the individual film layers.

Metals are typically used for the barrier and, because of economic concerns based on the cost of such materials, among other reasons, the barrier layer itself so thin and so sensitive that it must be protected on the inside, i.e., the side facing the product, while the limited-extensibility layer provides such protection on the outside.

To provide effective protection within an economically feasible framework, the inner protective layer must be as thick as possible. On the other hand, it must also be as thin as possible, in order to prevent the buildup of electrostatic charges and to allow a correspondingly low breakdown voltage to the barrier layer. It is important to prevent buildup of electrostatic charge, because otherwise there is a risk of explosion or deflagration caused by electrostatic charges. This is particularly a risk with many dust-like or powder-like products and, for this reason, the container must be a construction that can be grounded or dissipate electric charge.

The materials suitable for such inner protective layers are generally not approved for foodstuffs, for example, when they are made with plastic that has an antistatic agent. Furthermore, such materials exhibit poor heat-sealing properties. This either makes it problematical to produce a container from suitable film pieces, or the container is not as durable as desired.

Inner protective layers that are approved for foodstuffs and that also have good heat-sealing properties, however, exhibit such high electrical resistances which can, for example, be brought to an appropriate, low breakdown voltage by using the above-mentioned mechanical perforations. This, however, then results in the official approval for use with foodstuffs no longer being given.

### BRIEF SUMMARY OF THE INVENTION

The object of the present invention is to create a multi-layer film for manufacturing a flexible container, as well as a flexible container manufactured from the multi-layer film. Both the film and the container provide optimal product protection by means of a barrier layer, as well as product protection in the area of the sealing seam due to high sealing seam strength. They also serve to dissipate electrical charge and thereby prevent the buildup of electrostatic charge and the risks associated with the buildup. The multi-layer film and flexible container are thus also applicable for use with foodstuffs or pharmaceutical products. Materials that are used to package foodstuffs are subject to official approval. Hereinafter, materials that are deemed approved for use with foodstuffs will be referred to as “foodstuff-safe”.

This object is achieved by providing a multi-layer film that has a barrier layer, a plastic layer of limited extensibility, and an antistatic plastic layer. The antistatic plastic layer is provided on the side of the barrier layer that is opposite that of the limited-extensibility layer. Adjacent the antistatic plastic layer and facing away from the barrier layer is a layer of a foodstuff-safe material. This layer of foodstuff-safe material has a thickness from 5 to 20 microns. The antistatic plastic layer has a thickness approximately from 10 to 150 microns. The antistatic plastic layer may be formed from foodstuff-safe material that contains a foodstuff-safe antistatic agent. The flexible container is a container that has walls formed of the flexible multi-layer film just described.

In other words, the invention proposes to provide a limited-extensibility plastic layer on one side of the barrier layer and an antistatic plastic layer on the other side with. Two different ways of constructing the antistatic plastic layer will result in an antistatic plastic layer that is foodstuff-safe:

According to a first embodiment, an antistatic layer that is possibly not approved for contact with foodstuffs is covered with a layer that is foodstuff-safe. Despite its thin layer thickness according to the invention, the foodstuff-safe layer separates the foodstuff that is possibly packaged in the film from the antistatic plastic layer. The thin layer thickness makes it possible to keep the breakdown voltage of the film low enough to avoid unallowably high electrostatic charges.

According to a second embodiment, the antistatic layer is made of a foodstuff-safe plastic, as well as an additive in the form of a foodstuff-safe antistatic agent. It is, thus, not necessary to provide a separation between the foodstuffs that may possibly be packed in the film and the antistatic plastic layer. Even with a thicker antistatic plastic layer is thicker, the breakdown voltage of the film may still be kept sufficiently low.

An “antistatic” layer according to the invention must be distinguished from a “charge dissipative” layer. Charge dissipative materials frequently contain an admixture of carbon. A corona treatment, such as is performed on other film materials in preparation for bonding, can therefore not be performed on dissipative materials. These materials are therefore poorly bondable and poorly heat-sealable and, thus, exhibit weak seams.

In contrast to the dissipative materials, making the plastic layer in the form of an antistatic plastic layer provides considerably better heat-sealing properties, so that a reliable barrier effect is ensured not only across the surface of the film due to the barrier layer, but also in the area of the sealing seams, when, for example, the film is made into a container. A high sealing seam strength is achievable with this construction, so that optimal product protection is provided in this area, too.

Sealing seams of such high strength could also be guaranteed, if the antistatic property of the corresponding plastic layer is eliminated. According to the invention, however, the advantage is achieved because the antistatic construction of the plastic layer maintains a breakdown voltage of less than 4 kV. As a result, static charges, for example, of a container made from the film, do not occur at an impermissible level. Rather, the electrical charges dissipate when they reach the breakdown voltage, thus achieving a particularly high measure of safety, not only for the product itself, but also for equipment and personnel.

The following structure produces the film according to the invention particularly economically: The barrier layer has a limited-extensibility layer on one side; and, on the other side, namely, on the side facing the product to be packaged, an antistatic plastic layer. If necessary, a foodstuff-safe layer is provided as the next adjacent layer and a foodstuff-safe layer provided as the surface layer on the side opposite the limited-extensibility layer. If the individual film layers are not, for example, bonded with each other during the extrusion process, bonding agents may be provided, if necessary, as additional materials; otherwise additional materials and additional layers may be eliminated, which is an economic advantage.

Containers for packaging foodstuffs may be produced from the film according to the invention, because the antistatic layer is either provided with a layer of material that is foodstuff-safe or itself made of a foodstuff-safe material.

The barrier layer may advantageously be a metallic layer, for example, of gold or another metal. Advantageously, the barrier layer may be made of aluminum in a conventional manner. This material may be obtained and processed at a reasonable cost, and it has the desired advantageous barrier properties, for example, it is impermeable to steam and, if necessary, light and oxygen. It is also electrically dissipative.

Advantageously, the limited-extensibility layer may be made of polyester (PET) in a conventional manner. This material is easily bondable or combinable with the barrier layer, especially one made of aluminum, and is easily adaptable to the extensibility of the barrier layer, so that the barrier layer is protected against over-extension. Alternatively, the limited-extensibility plastic layer may be made of oriented polypropylene (OPP), whereby, however, both PET and OPP are named merely as examples of materials that have proven suitable in practical trials.

Advantageously, the antistatic layer may be made of polyethylene with an antistatic agent added to it. Such antistatic agents are commercially available from various manufacturers. In one embodiment of the present invention, the antistatic agent may be advantageously approved for foodstuffs, making it unnecessary to cover the antistatic layer with a foodstuff-safe layer.

Advantageously, a permanent antistatic agent may be used, the efficacy of which is also guaranteed beyond the period of 18 months, which is the otherwise conventional guarantee period for antistatic agents. The container according to the invention may be used repeatedly or stored, either empty or filled with a product, over a longer period time, whereby even then the effectiveness of the antistatic agent is also ensured.

Advantageously, the foodstuff-safe layer may be made of polyethylene, for example, of pure polyethylene.

Since the breakdown voltage of the foodstuff-safe layer may be relatively high and, for example, is relatively high in the case of pure polyethylene, the foodstuff-safe layer is preferably relatively thin, namely, from approx. 5 to 20 microns thick. In particular, the layer thickness may be approx. 10-15 microns, which ensures that, on the one hand, the breakdown voltage is not undesirably high, yet, on the other hand, the layer has sufficient mechanical stability, so that damage to this layer, and, thus, undesirable contact of the product in the container with something other than the foodstuff-safe layer may be reliably prevented.

The antistatic layer may have a layer thickness of approx. 10 to approx. 150 microns, whereby a thin layer thickness makes it possible to keep the breakdown voltage low, while a thicker layer thickness provides for a better sealing seam strength.

In contrast to the foodstuff-safe layer, the antistatic layer may, without causing a problem, be considerably thicker, namely, for example, from 60 to 100 microns thick. Due to the antistatic agent itself in a composite structure comprising both layers, that is, the foodstuff-safe layer plus the antistatic layer, the required breakdown voltage of maximum 4 kV may be maintained problem-free until it reaches the barrier layer, thus producing a charge dissipative film.

In particular, the entire antistatic layer may be thicker than 100 microns, when the layer is made of foodstuff-safe material. This is because an additional foodstuff-safe layer that increases the breakdown voltage is not necessary. Thus, an optimal sealing seam strength may be obtained by selecting a suitable plastic material for the antistatic layer.

In particular, the excellent sealing seam strength afforded by polyethylene (PE) is ensured even then, when the antistatic layer is also basically made of polyethylene, as is the possibly provided foodstuff-safe layer. This is so, even if the layer made of pure PE is relatively thin and not thick enough for achieving a sufficiently strong sealing seam. Selecting PE as the base material for the antistatic layer provides a sealing seam strength that enables the thinnest possible construction of the foodstuff-safe layer and nevertheless guarantees that a breakdown voltage of a maximum of 4 kV is reliably maintained.

It is advantageous that the surface of the film opposite the limited-extensibility layer be free of regular indentations created by the manufacturer, for example, grooves, perforations, and such, to prevent residues or impurities from adhering in such indentations, particularly when packaging highly sensitive materials. Furthermore, the closed surface construction guarantees that there is no possible contact between the product and the barrier layer, which, depending upon the product, may be particularly undesirable if the barrier layer is made of metallic material.

Advantageously, a flexible container may be made from the described film, for example, in the form of packaging that is made solely of film or an inner container of another container or an “inliner” made of film, for example, for a Big Bag made of a woven textile fabric, for cardboard packaging, such as so-called Octabins, or also for small packaging, such as, sacks made of a plastic film that can hold approx. 25 to 50 kg.

Advantageously, the film according to the invention, or rather the container made of the film, is groundable. In this regard, various measures are known in the industry. Grounding clamps that are attached directly to the inliner may provide the grounding, so that no special grounding clamp is necessary on the outer container.

Advantageously, the limited-extensibility layer at the edges of the barrier layer may be narrower than the barrier layer, so as to leave a strip of the barrier layer uncovered. Thus, a Big Bag inliner may be made from such a film that has exposed areas on the edge of the barrier layer. These exposed areas facilitate a problem-free electrically conducting connection, for example, to clamps that ground the container. The ability to create a ground may then be guaranteed without having to add additional materials to the film material, or additional components, such as the aforementioned grounding clamps.

### BRIEF DESCRIPTION OF THE DRAWINGS

An embodiment of a film according to the proposal is described in detail below using a strictly schematic drawing.

FIG. 1 is an exploded perspective view of the film according to the invention.

### DETAILED DESCRIPTION OF THE INVENTION

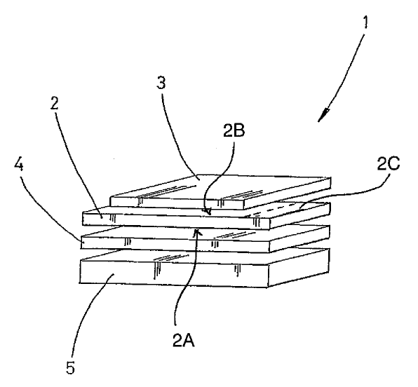

FIG. 1 shows a multi-layer film 1 according to the invention. The reference designation 1 is used to indicate the entire multi-layer film, whereby the individual layers are presented purely schematically, with the individual layers pulled apart. The illustration is not true to scale. For the sake of clarity, the provided connective materials which may possibly be needed, e.g., bonding agents, etc., have been eliminated in this illustration.

The film 1 has a barrier layer 2 made of aluminum that is coated on one side with a layer 3 made of a polyester material having limited extensibility. The barrier layer 2 has a first side 2A that faces inward, i.e., faces toward the product that is packaged within a container or sack made of the film 1, and a second side 2B that faces outward, i.e., faces away from the product. The limited-extensibility layer 3 does not extend over the entire width of the barrier layer 2, that is, over the entire width of film 1, but rather, leaves two marginal strips of the barrier layer 2 uncovered. A marginal strip 2C is indicated with dashed lines on the second side 2B of the barrier layer 2.

The barrier layer 2 is coated on the first side 2A with a layer 4 made of antistatic material, whereby this antistatic layer 4 has a layer thickness of approx. 70 microns. This antistatic layer 4 may comprise a single layer or several layers, and possibly co-extruded layers, and is made basically of polyethylene with an admixture of a commercially available permanent antistatic agent. The antistatic additive in the polyethylene is proportioned according to the layer thickness of the antistatic layer 4, as well as to the layer thickness of an additional surface layer 5. This layer 5, made of a foodstuff-safe material, is made of pure polyethylene, and its layer thickness is 13 microns. The layer thicknesses of layers 4 and 5 and the portion of antistatic material in the antistatic layer 4 are balanced with each other overall, so as to safely maintain a breakdown voltage of less than 4 kV from the surface of foodstuff-safe layer 5 through to the barrier layer 2.

Flexible containers may be manufactured using the shown film, whereby it is particularly advantageous that layer 5 face inward toward the product, so that foodstuffs may be packaged problem-free inside such a flexible container.

An excellent sealing seam strength for film 1 is reliably achieved, when the innermost layer 5 has a relatively thick layer thickness. This creates a risk, however, that the desired breakdown voltage of maximal 4 kV will not be maintained, but rather, that this value will be exceeded.

Good seam sealing strength is achieved, when the innermost foodstuff-safe layer 5 is eliminated, because the base material of the antistatic layer 4 itself is polyethylene. Depending on how the antistatic property is provided in the antistatic layer 4, however, the film may then not be suitable for packaging food, because the layer of the food packaging container that faces the food may not be a foodstuff-safe material. This becomes an issue when, for example, a certain antistatic agent is used.

If, however, as an alternative to the aforementioned embodiment, the antistatic layer 4 has both a base material that is recognized as safe for foodstuffs, e.g., polyethylene, and foodstuff-safe antistatic agent, then the entire antistatic layer 4 becomes foodstuff-safe and may be used for packaging foodstuffs. This embodiment also provides excellent sealing seam strength of the film 1.

1-14. (canceled)

15. A flexible container that forms an inliner for use with an outer container, said inliner having an inner side that faces toward an inner space formed by said flexible container and an outer side that faces toward said outer container, said flexible container comprising:
container sides formed by a multi-layer film that comprises a barrier layer, a limited extensibility plastic layer, an antistatic plastic layer, and a foodstuff-safe plastic layer;
wherein the barrier layer has a first side that is intended to face toward said inner space and a second side that is intended to face toward said outer container,
wherein said antistatic plastic layer is provided on said first side of said barrier layer and said limited extensibility plastic layer is provided on said second side of said barrier layer, and said foodstuff-safe plastic layer is provided on a side of said antistatic plastic layer that faces toward said inner space; and
wherein said foodstuff-safe plastic layer has a thickness in a range from 5 microns to 20 microns, and the antistatic plastic layer has a thickness from approximately 10 to 150 microns.

16. The flexible container of claim 15, wherein said barrier layer is made of aluminum.

17. The flexible container of claim 15, where the limited extensibility plastic layer is made of polyester.

18. The flexible container of claim 15, wherein said antistatic plastic layer is made of a polyethylene that contains an antistatic agent.

19. The flexible container of claim 15, wherein the antistatic plastic layer contains a permanent antistatic agent.

20. The flexible container of claim 15, wherein the layer made of foodstuff-safe material is made of polyethylene (PE).

21. The flexible container of claim 15, wherein the antistatic plastic layer has a thickness in a range from 70 to 100 microns.

22. The flexible container of claim 15, wherein an innermost surface of said inliner facing said inner space is free from recesses.

23. The flexible container of claim 15, wherein said multi-layer film is electrostatically dissipative.

24. The flexible container of claim 23, wherein said barrier layer is electrostatically dissipative and wherein said limited extensibility plastic layer is dimensioned to be narrower than an overall width of said inliner, so as to leave uncovered a strip of barrier layer.

25. A flexible container that forms an inliner for an outer container, said inliner having an inner side that faces toward an inner space formed by said flexible container and an outer side that faces toward said outer container, said flexible container comprising:
container sides formed by a multi-layer film that comprises a barrier layer, a limited extensibility plastic layer, and an antistatic plastic layer made a of foodstuff-safe material and a foodstuff-safe antistatic agent;
wherein the barrier layer has a first side that is intended to face toward said inner space and a second side that is intended to face toward said outer container, and said antistatic plastic layer is provided on said first side of said barrier layer.

26. The flexible container of claim 25, wherein said barrier layer is made of aluminum.

27. The flexible container of claim 25, where the limited extensibility plastic layer is made of polyester.

28. The flexible container of claim 25, wherein said antistatic plastic layer is made of a polyethylene that contains an antistatic agent.

29. The flexible container of claim 25, wherein the antistatic plastic layer contains a permanent antistatic agent.

30. The flexible container of claim 25, wherein the layer made of foodstuff-safe material is made of polyethylene (PE).

31. The flexible container of claim 25, wherein the antistatic plastic layer has a thickness in a range from 70 to 100 microns.

32. The flexible container of claim 25, wherein an innermost surface of said inliner facing said inner space is free from recesses.

33. The flexible container of claim 25, wherein said multi-layer film is electrostatically dissipative.

34. The flexible container of claim 25, wherein said barrier layer is electrostatically dissipative and wherein said limited extensibility plastic layer is dimensioned to be narrower than an overall width of said inliner, so as to leave uncovered a strip of barrier layer.
